(19) United States
(12) Patent Application Publication
(10) Pub. No.: US 2021/0244584 A1
(43) Pub. Date: Aug. 12, 2021

(54) Stand Assist Stool and Method

(71) Applicant: William Masters, Greenville, SC (US)

(72) Inventor: William Masters, Greenville, SC (US)

(21) Appl. No.: 16/788,844

(22) Filed: Feb. 12, 2020

(51) Int. Cl. A61G 5/14; A47C 16/02; A47C 7/74; A47K 17/02

(52) U.S. Cl. CPC A61G 5/14; A47K 17/028; A47C 7/748; A47C 16/02

(57) ABSTRACT

A stand assist stool includes a main body member having a base member, and an inclined platform that is positioned above the base member. The stand assist stool, in one embodiment, may include a semi-circular indentation on a rear portion thereof to accommodate the base of a toilet, so that the stand assist stool may be positioned around the base of a toilet. Additionally, the inclined platform may include a cover, such as a carpet type of material, non-skid material, or any desired covering, and may also include a toilet riser on a rear portion thereof, which may be installed underneath a toilet to raise it up to a desired height, so that the inclined platform is attached to a front portion of the toilet riser. Optionally, the stool may be pivotally connected to a toilet so that it flips upwardly when not in use.

### BACKGROUND OF THE INVENTION

As the average lifespan of humans continues to increase, and it is not uncommon for people to live beyond 80 or even 90 years in many cases, this trend has spawned the development of many new products to assist people who have lost some of their strength, balance or other physical capabilities. One issue that comes with advanced age is the inability for a person to stand up from a seated position. To address this issue, people and companies have developed and commercialized various products to assist a person's efforts to stand up after being seated on a chair, couch, toilet or the like. For example, recliner chairs have been designed to lift slightly and tilt forward when a user is ready to stand up, and many restrooms now include handles or support bars adjacent a toilet. There are also devices that may be installed underneath a toilet having a standard height in order to raise the height of the toilet seat to facilitate standing up.

Another trend that has been observed in recent years is the commercialization of toilet stools, which raise a user's feet while sitting on a toilet, so that the person is disposed in a simulated squatting position. One such toilet stool is widely available, and is marketed as a SQUATTY POTTY, based on the theory that defecating from a squatting position is easier and healthier than from a normal seated position.

Various types of stools, including toilet stools, have been developed for this purpose. The following documents illustrate examples of these types of products, and are hereby incorporated herein by reference, in their entireties:

U.S. Pat. No. 9,307,879 Body Positioning Systems

A system related to providing elevated support and positioning of the feet to place the body of a user in a posture facilitating bowel elimination during seated-position toilet use.

U.S. Application Publication No. 20160360937 Stool for Use with a Toilet

A stool is provided that provides a raised heel squat position to a user that engages the stool. The raised heel squatting position promotes a healthy and productive experience on a toilet. The stool may be collapsible for easier storage and transportation. The stool may be adjustable to provide custom fittings to different size users. Additionally, the stool may be intelligent and may provide a customized immersive experience to a person on a toilet.

Additionally, several design patents show toilet stools and similar products, and these references are also incorporated herein by reference: U.S. design Pat. Nos. D785,351; D787,846; D787,847; and D834,341.

The references cited above are all directed toward stools that are used to facilitate bowel movements in a simulated squatting position. However, none of these devices are designed or used to assist a person in the act of standing up from a seated position. Therefore, it would be desirable to provide an inclined stool that is used to assist a user in standing up from a seated position, either from a toilet, a chair, a couch, or the like.

### BRIEF SUMMARY OF THE INVENTION

In accordance with one aspect of the invention, a first embodiment of a stand assist stool includes a main body member having a base member, and an inclined platform that is positioned above the base member. The stand assist stool may be formed into a solid shape, or may be hollow on an inner portion thereof with vertical sides and/or other support members to support the inclined platform.

The stand assist stool, in one embodiment, may include a semi-circular indentation on a rear portion thereof (on the raised side) to accommodate the base of a toilet, so that the stand assist stool may be positioned around the base of a toilet. Additionally, the inclined platform may include a cover, such as a carpet type of material, non-skid or non-slip material, or any desired covering, which is preferably removable for washing or cleaning, but which is also securable to the stool so that it does not move or slide with respect to the stool while in use.

In another embodiment, the stool may also include a toilet riser on a rear portion thereof, which may be installed underneath a toilet to raise it up to a desired height, so that the inclined platform is attached to a front portion of the toilet riser. In this embodiment, the toilet riser portion of the stand assist stool is similar to toilet risers that are commonly available today (having a hole extending therethrough in a vertical direction to accommodate the plumbing in the bottom portion of a toilet bowl), and including the inclined platform on a front portion thereof where a user's feet would usually be positioned while sitting on a toilet.

Other embodiments may include other features, such as indentations on a rear portion for accommodating the legs of a stationary chair or a rolling office chair

In each of these embodiments, the inclined platform raises the heels higher than the toes while a user is in the act of standing up, and tends to drive the user's center of gravity in a forward direction during the standing process. The inclined platform reduces the strain on a user's leg muscles, and further, reduces the amount of strength and effort that is required to stand from a seated position.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of a stand assist stool having a base member, an inclined platform disposed above the base member, an indentation on a rear side thereof, and a removable, non-skid cover attached to an upper surface of the inclined platform;

FIG. 2 is a perspective view of one embodiment of a stand assist stool having a base member, an inclined platform disposed above the base member, and a removable, non-skid cover attached to an upper surface of the inclined platform, and further showing hook and loop attachment means for removably attaching the cover to the inclined platform;

FIG. 3 is a perspective view of one embodiment of a stand assist stool having a base member, an inclined platform disposed above the base member, and a removable, non-skid cover attached to an upper surface of the inclined platform, and further showing the stand assist stool in position adjacent a toilet;

FIG. 4 is a perspective view of another embodiment of a stand assist stool having a base member, an inclined platform disposed above the base member, a pair of indentations on a rear side thereof to accommodate chair legs or the like, and a removable, non-skid cover attached to an upper surface of the inclined platform;

FIG. 5 is a perspective view of one embodiment of a stand assist stool having a base member, an inclined platform disposed above the base member, and a removable, non-skid cover attached to an upper surface of the inclined platform;

FIG. 6 is a cut-away view of one embodiment of a stand assist stool that is pivotally attached to a toilet riser that is positioned beneath the toilet, wherein the stand assist stool includes a base member, an inclined platform disposed above the base member, and a removable, non-skid cover attached to an upper surface of the inclined platform, and wherein a rod extends horizontally through the stand assist stool and through the toilet riser, so that the stand assist stool may be pivoted upwardly to a generally vertical position when not in use;

FIG. 7 is a perspective view of the embodiment of a stand assist stool shown in FIG. 6;

FIG. 8 is a perspective view of one embodiment of a stand assist stool that is integrally formed with a toilet riser that is positioned beneath the toilet, including a base member, an inclined platform disposed above the base member and in front of the toilet riser portion, and a removable, non-skid cover attached to an upper surface of the inclined platform; and

FIG. 9 is a side cross-sectional view of one embodiment of a stand assist stool, and also showing a human foot and bone structure.

### DETAILED DESCRIPTION OF THE INVENTION

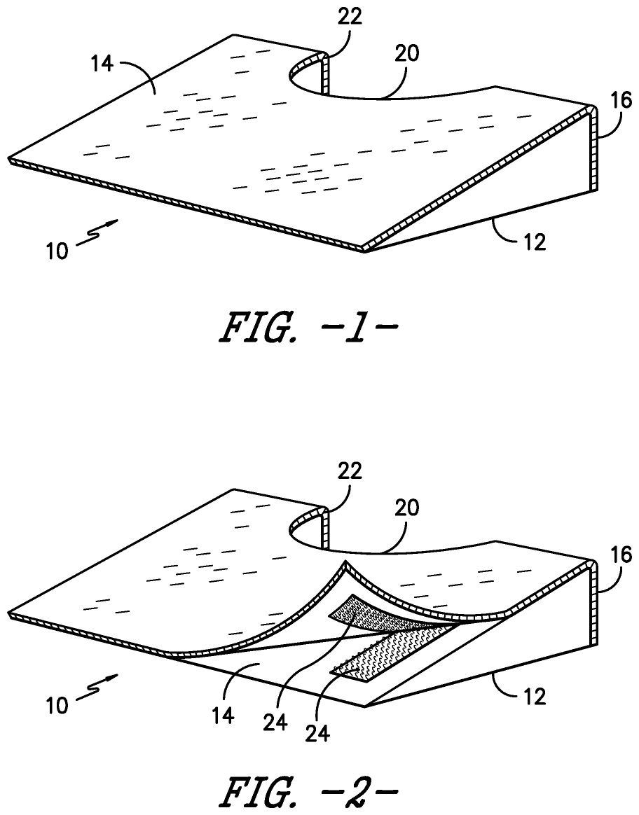

A first embodiment of a stand assist stool is shown in FIG. 1, and includes a main body member 10 having a base member 12 and an inclined platform 14 above the base member 12. The concept behind the stand assist stool is to provide an inclined platform 14 that raises a user's heels to a higher level than the user's toes, similarly to women's high heels, which tends to propel the user forward during the act of standing up from a seated position. In use, the raised side 16 of the stand assist stool is placed against or adjacent to the front of a chair, couch, toilet 18, or the like so that the raised side 16 is closest to the user (under a user's heels) while the lower portion is in on the distal side away from the user (under the user's toes), as shown in FIG. 9. In a preferred embodiment, the inclined platform should have an angle above horizontal within the range of 3 to 35° above a horizontal plane, although other angles may be used, as desired.

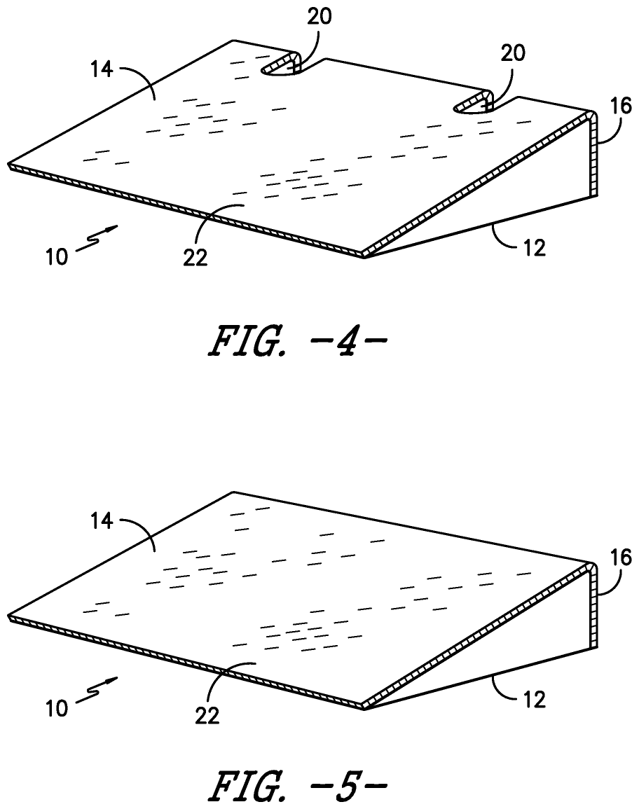

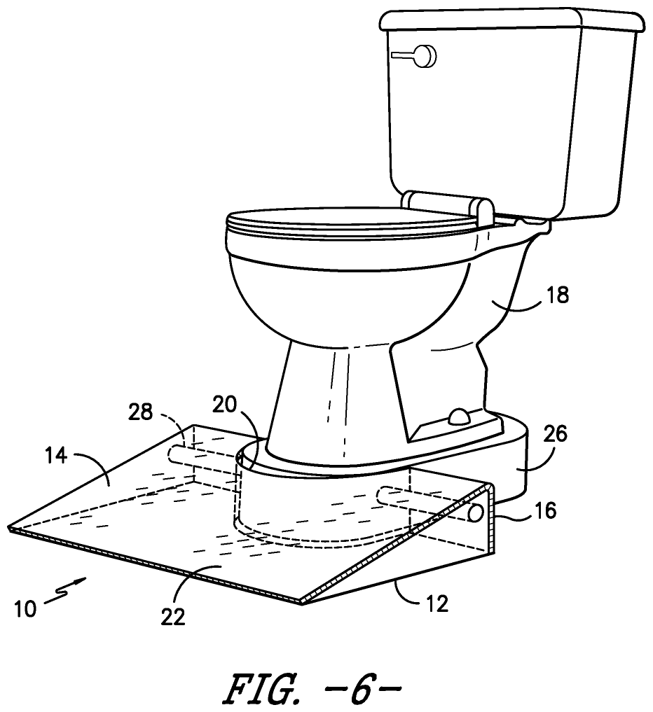

In order to properly position the stand assist stool adjacent a seat, the rear side 16 of the stool, which is the raised side 16, may include one or more indentations 20 that allow the stool to be placed snugly against the seat while accommodating the support(s) for the seat, such as chair legs or the base of a toilet 18. For example, in the embodiment shown in FIG. 3, a semi-circular indentation 20 is positioned in the central portion of the rear side 16 of the stool so that the stool may fit around the base of a toilet 18, thereby allowing the inclined platform 14 to be in proper position to assist a user seated on a toilet 18. In another embodiment, a pair of spaced indentations 20 may be provided on a rear portion thereof in order to fit around a pair of chair legs, as shown in FIG. 4. For seats with a flat front, such as a couch, the rear portion 16 of the stool may simply be flat with no indentations present, as shown in FIG. 5.

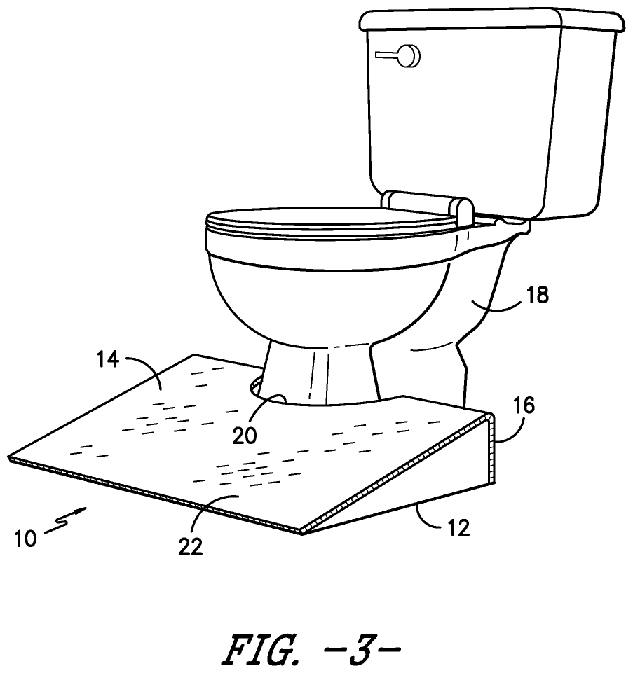

Optionally, a cover 22 may be removably or permanently secured to the inclined platform 14 to provide a non-slip surface, or to provide a softer, more comfortable surface for standing. The cover 22 may be made from any suitable material, such as carpet, rubber, foam, or the like. Preferably, the cover 22 is removably secured to the inclined platform 14, so that it may be removed for washing or cleaning, and it should be understood that the cover may be secured in place on the inclined platform 14 sufficiently to prevent it from sliding around or moving during use. Removably securing the cover to the inclined platform may be accomplished using any suitable means, including hook and loop fasteners (VELCRO) 24 (as shown in FIG. 2), strips of material having a tacky adhesive, clips, snap-fit mechanisms, or any other means, all of which are well known in the art.

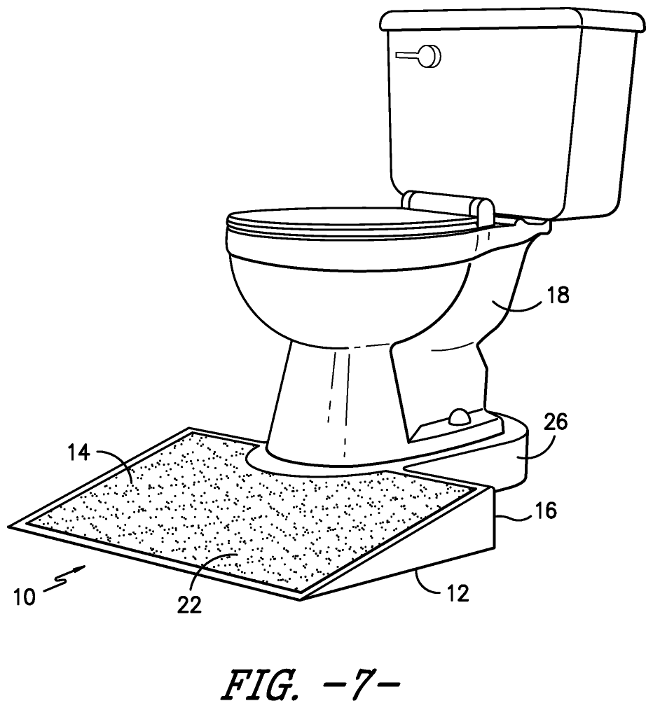

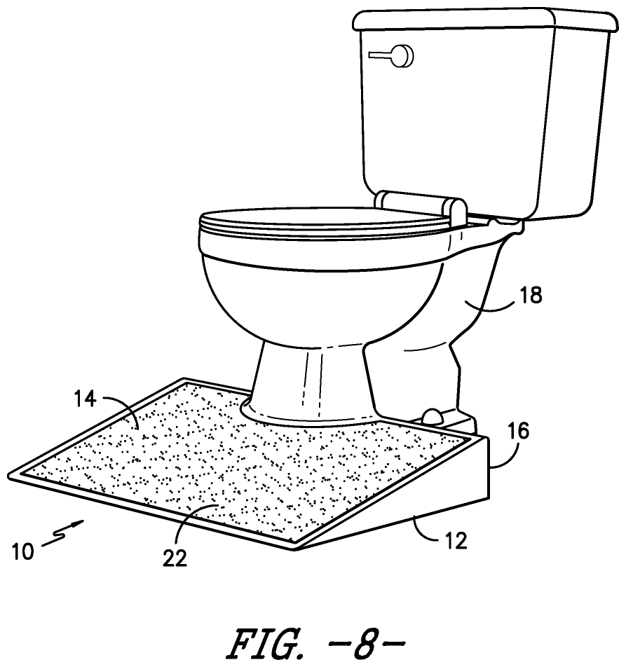

In one embodiment, the stand assist stool includes two sections: the inclined platform 14 on a front portion, and a toilet riser 26 on a rear portion thereof, as shown in FIGS. 6-8. This embodiment requires installation beneath a toilet 18 similarly to commercially available toilet risers, and serves two primary purposes: it raises the level of the toilet seat to facilitate the process of standing up, and it further provides an inclined surface 14, which reduces the effort and muscle strain of standing up from a seated position. Toilet risers are commercially available, and typically include a vertical hole or opening in a central portion thereof, in order to accommodate the plumbing that is operatively connected to the bottom of a toilet bowl.

Optionally, the inclined platform 14 portion of the stool may be pivotally or hingedly connected to the toilet riser portion, so that the inclined platform may be rotated upwardly (similarly to a toilet seat) when the inclined platform portion is not being used. For example, FIG. 6 shows one embodiment of a stand assist stool that is pivotally attached to the toilet riser portion 26, wherein a rod 28 extends through holes in the rear portion of the stand assist stool, and further extends through a hole in the toilet riser portion, so that the stand assist stool may be pivoted to a generally vertical position when not in use.

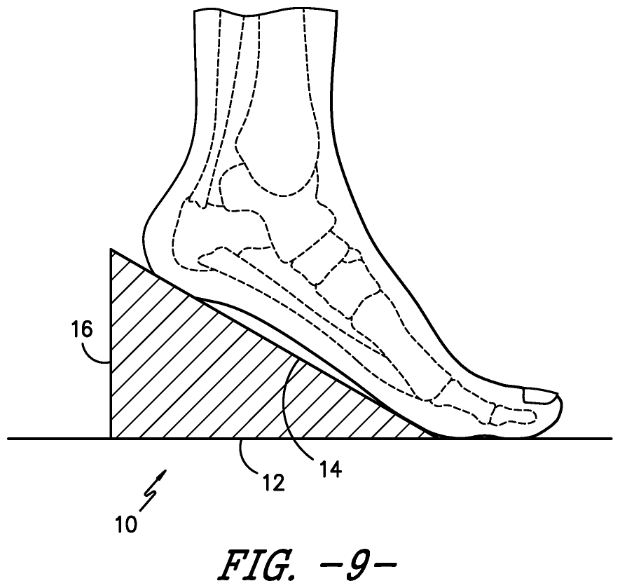

In yet another embodiment, the inclined platform 14 may be integrally formed with the toilet as a single unit, as shown in FIG. 8. In this embodiment, the inclined platform may be made from porcelain (or any other suitable material), and may include a non-skid surface, similarly to other embodiments described herein.

In another embodiment, the stool may be pivotally or hingedly attached directly to an existing toilet 18, so that the stool may be flipped upwardly when not in use. This embodiment may include standard hinges that are attached to the base of the toilet and the rear portion of the stool, or the stool may simply pivot about a rod that runs through a hole in the base of the toilet, and extends horizontally through holes in the rear portions of the stool on either side of the indentation.

In one form, the stool may comprise two separate inclined platforms that are connected by a support member, such as a board or rod.

Any of the previously described embodiments of the stand assist stool may also include means for adjusting the height and/or incline angle of the inclined platform. The adjustment means may be of any suitable type, and are well-known in the art, particularly as described in U.S. Application Publication No. 20160360937 Stool for Use with a Toilet, which is incorporated herein by reference. Alternatively, the height and angle of the inclined platform may be adjusted using electrical or pneumatic means, either of which could be accomplished by one skilled in the art.

Additionally, other features may be included, including lights, strip lights, LED light strips, rope lighting, and individual lights in any desired location on the stand assist stool. These lights may include an electrical cord that may be plugged into an outlet, or may be battery operated, and the lights also preferably include a motion sensor and a light sensor, so that the lights are only activated when the ambient lighting is dark and the motion sensor detects motion.

If desired, the stool may be heated, as well, by including commonly used heating elements, similar to those used for electric heated blankets, or the like. In one embodiment, the heating element may be placed between the inclined platform 14 and the cover 22, or the heating element may simply be integrated into either the inclined platform 14 or the cover 22.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A stand assist stool comprising:
a main body member having a front side, a rear side, and right and left sides, a base member and an inclined platform disposed above said base member, and further including at least one indentation on a rear side thereof.

2. The stand assist stool set forth in claim 1, further including a removable cover attached to said inclined platform.

3. The stand assist stool set forth in claim 2, further including a toilet riser portion positioned on a rear portion of said main body member.

4. The stand assist stool set forth in claim 3, wherein said main body member is pivotally attached to said toilet riser portion.

5. The stand assist stool set forth in claim 3, wherein said main body member and said toilet riser portion are integrally formed together as a single monolithic structure.

6. The stand assist stool set forth in claim 1, wherein said rear side of said main body member is attached to a base of a toilet.

7. The stand assist stool set forth in claim 1, wherein said inclined platform is inclined at an angle of between 3° and 35° above a horizontal plane.

8. The stand assist stool set forth in claim 1, further including a heating element attached to said inclined platform.

9. A method of assisting a person to stand up from a seated position, said method comprising the steps of:
providing a stand assist stool having a main body member, having a front side, a rear side, and right and left sides, a base member and an inclined platform disposed above said base member;
positioning said stand assist stool in front of a seat;
assuming a seated position on said seat so that at least one foot is positioned on said inclined platform where the person's heel is positioned higher than the person's toes on said inclined platform; and
rising to a standing position on said stand assist stool.

10. The method set forth in claim 9, further including the steps of:
providing a toilet riser portion;
positioning said toilet riser portion beneath a toilet; and
pivotally connecting said stand assist stool to said toilet riser so that said stand assist stool may rotate to a vertical position when not in use.

11. The method set forth in claim 9, further including the steps of:
providing a removable cover and attaching said removable cover to said inclined platform.

12. The method set forth in claim 11, wherein said removable cover includes non-skid properties.

13. The method set forth in claim 9, wherein said stand assist stool includes a toilet riser portion attached to said rear side thereof.

14. The method set forth in claim 9, wherein said rear side includes at least one indentation; and
positioning said stand assist stool adjacent a seat support so that said seat support is positioned within said indentation on said rear portion of said stand assist stool.
